(19) United States
(12) Patent Application Publication
(10) Pub. No.: US 2002/0139376 A1
(43) Pub. Date: Oct. 3, 2002

(54) Custom fitted personalized mouthguard

(76) Inventor: Jude Michael Waddy, Tampa, FL (US)

Correspondence Address: Jude Michael WADDY, 14603 PAr Cluh Circle, TAMPA, FL, 33624, US

(21) Appl. No.: 10/046,950

(22) Filed: Jan. 17, 2002

Related U.S. Application Data
(60) Provisional application No. 60/266,277, filed on Feb. 2, 2001.

(51) Int. Cl. A61C 5/14

(52) U.S. Cl. 128/861

(57) ABSTRACT

A custom fitted, 2 layered mouthguard apparatus consisting of a standard U-shape configuration with personalized images engraved upon the primary layer within the region of the anterior incisors also with optional manipulated forms that will increase the appeal of the mouthguard to potential users. The engraved area is colored to distinguish the designs from the base color of the mouthguard. Upon the completion of the coloring process the mouthguard is covered with a clear layer of thin pressure laminated thermoplastic material, which is interdentated to provide a more comfortable Temporomandibular fit.

### REFERENCES CITED

U.S. patent Documents

| | | | |
|---|---|---|---|
| 3407808 | October 1964 | Baldwin | 128/862. |
| 3089487 | May 1960 | Enicks et al. | 128/861. |
| 2706478 | May 1952 | Porter | 128/862;84/453. |
| 5931164 | August 1999 | Kiely | 128/859,852. |
| 6082363 | July 2000 | Washburn | 128/859,861,862. |
| 5692523 | December 1997 | Croll et al. | 128/859,861. |

### FIELD OF THE INVENTION

The present invention relates generally to protective mouthguards for use by athletes, particularly to a mouthguard that absorbs, and dissipates shock forces related to athletic activity and stresses exerted onto the teeth, jaw, gums, and joint structures.

### BACKGROUND

These protective mouthguards are intended for all athletic activities including contact sports and X-treme sporting activities. Custom fitted mouthguards offer better protection to the teeth and the temporomandibuliar joint during athletic activities. There is a need to produce a comfortable, practical, and appealing mouthguard providing a more comfortable fit and, individualized features that will encourage sporting enthusiasts as well as professional athletes to protect their teeth and reduce the risk of injury.

### SUMMARY OF THE INVENTION

This custom mouthguard is unique in its ability to appeal to the competitive athlete as well as the trendy, occasional sporting enthusiast. The idea of personalizing protective mouthguards creates a new appeal to athletes that will allow the user to express him/her self in a way that is not available in the prior art. This mouthguard provides high quality of protection to the teeth and gums of the user because of the rigidity of the pressure laminated plastic and, having a firm contact surface for the molars and bicuspids. The area of the rear upper molars and bicuspids are interdentated on the biting surface by manipulating that region of the mouthguard with heat and an impression of the lower molars and bicuspids to ensure a more comfortable position of the temporomandibular joint during usage in high contact activities.

The formation of the mouthguard involves a layering process where pressure laminated thermoplastic layers are formed over a mold of the user's upper impression by a vaccuforming machine until the desired level of protection are achieved. The layering process adds a dimension of protection that dissipates external shock forces during sporting activities. Shock forces are decreased dramatically throughout the mouthguard due to the enhanced properties provided by the layering process. This quality makes the mouthguard more appealing to the sporting consumer due to the fact that the mouthguard can provide maximum levels of protection with a combined effort of two layers of thermoformed pressure laminated plastic resulting in a thinner more comfortable mouthguard. Once the level of protection is determined the base level is formed to provide a suitable layer to engrave and form the elongated canines. The mouthguard is then engraved by a 25 watt or more powerful laser engraver. Following the engraving process the mouthguard is painted and decorated. Any paint can be used because the painted layer will be covered. Nontoxic paint is ideal because of its properties, in the event of a leakage, or break in the seal the user will not be effected. After a period of about an hour a final layer of thermoplastic material is applied to cover the engraving and the paint. The mouthguard is interdentated thus providing a more natural fit for the wearer by modifying the rear bicuspids and molars. The final step is to buff the mouthguard to a shine, enhancing the appearance. The personalized aspects of the mouthguard makes the protective device appealing to both the professional athlete as well as the occasional sporting enthusiast. Finding a way to encourage the use of protective devices like mouthguards are as promising as finding a non threatening method to get drivers to use protective seat belts. Overall the mouthguard will encourage, through appeal, sporting enthusiasts to protect themselves during athletic endeavors because of the visual appeal of the mouthguard. This mouthguard will provide the maximum level of protection to the teeth and gums, but still allowing the user to breathe, and communicate more effectively than with the use of other mouthguards available today.

### BACKGROUND OF THE INVENTION

Mouthguards have been around for more than eighty years. Yet, very few are custom made. It is more beneficial to utilize a custom fitted mouthguard than a standard boil and bite mouthguard during athletic competition. Encouraging athletes to use mouthguards more often will reduce the chance of shock, concussions due to high impact collisions, blows to the head, and other injuries that occur during athletic competition. Failure to use a properly fitted mouthguard when impacts and collisions occur to the jaw structure and teeth of an athlete can result in that athlete's increased susceptibility to headaches, ear aches, ringing in the ears, vertigo, concussions and dizziness. So the problem lies in making the mouthguard appealing to the athlete while providing the maximum amount of comfort and protection. There are many types of mouthguards available to the consumer, but most of the mouthguards on the market provides a minimal amount of protection. A very low cost of sale poses as the primary benefit of use.

The prior art includes various types of custom-made mouthguards for example the mouthguard disclosed in U.S. Pat. No. 3,407,808 issued Oct. 1964. This mouthguard consists of a single layer custom made mouthguard, fabricated from an impression of a donor's upper teeth obtained from a dentist using thermoplastic material. This mouthguard only provides one layer of protection and a level of thickness that is uniform. The mouthguard is not interdentated so the user will experience substantial Temporomandibular joint discomfort. This mouthguard although custom, does not provide an adequate amount of protection and comfort thus rendering it obsolete. The mouthguard cited in the previous claims can be fabricated using a layering method making it stronger and thinner than the previously cited mouthguard by using more than one layer to absorb the impacts, and dissipate shock forces more efficiently possibly resulting from athletic competition.

Other types of mouthguards describe different methods of layering to add more protection. By adding multiple layers to the mouthguard it will increase its ability to absorb and dissipate the shock to the teeth and gums. The mouthguard mentioned in U.S. Pat. No. 3,089,487 May 1960, has a multi-layered design formed by painting a latex material onto an upper impression of a donor's teeth and baking the mouthguard in an oven at a temperature of 170* F. for an hour at a time. The process is repeated numerous times to buildup a sufficient amount of latex to provide ample protection for trauma to the teeth and gums. This process is lengthy and will drastically drive the production price skyward due to the high level of manual labor. This tedious process of building up layers to reach an ultimate desired level of protection is sound, but this technique is time consuming resulting in difficulty to mass produce. This mouthguard also allows an image to be seen through the layers of latex, usually a label identifying the user by name or number. This method of producing a mouthguard will result in a custom fitted mouthguard, but the ability to articulate the mouthguard and further personalize the mouthguard is not possible using this method of production. This mouthguard also leaves room for the possibility of uneven surfaces due to inconsistent layering of the latex resulting in an improper fit.

Yet another example of a mouthguard displays the incorporation of color as described in U.S. Pat. No. 2,706,478 May, 1952. Color is introduced to this mouthguard by adding a colored resin to the mold of the mouthguard during the mixing phase. This will uniformly color the mouthguard but in no way enable the color to be placed in a specific design, or pattern. This mouthguard only consists of 1 layer that only covers the lower teeth composed of wax, providing a minute amount of protection.

Another prior art mouthguard is U.S. Pat. No. 5,931,164 August 1999, wherein the mouthguard is colored by adding a light reflective aggregate distributed throughout the foundation. This mouthguard does incorporate color to differentiate the natural color of the base from the introduced aggregate, but the polyester aggregate is uniform throughout. This technique is unpredictable is the sense of personalizing the mouthguard to a specific individual. The mouthguard referred to in the previous claims possess the ability to effectively design and create images, words, or numbers to further personalize it to an individual user. The before mentioned mouthguard, U.S. Pat. No. 5,931,164, consist of only one layer to protect the user. The shock forces that occur during intense athletic competition can become too intense for the single layer of the Thermoformed plastic to dissipate, causing tooth damage and increasing the possibility of experiencing a concussion.

Accordingly, what is needed is a protective mouthguard that is durable enough to provide protection for the skilled professional athlete as well as the amateur sporting enthusiast. A mouthguard needs to be appealing to both the professional and the noncompetitive athlete to encourage safety in sport. By adding a dimension of personalization, the desire to utilize the mouthguard will increase making use of the protective mouthguard trendy. A mouthguard also needs to be resilient enough to absorb the impacts that may occur during athletic activities it must be able to dissipate shock and other external forces. The current state of off- the-rack and self-forming mouthguards provide only the convenience of an instant mouthguard. These mouthguards do not fit well to every individual and offer the minimum amount of protection available. Your teeth are subject to great trauma and are worth protecting, because once they're gone they are gone forever. The custom mouthguards that are available do offer a significant amount of protection but, offer few means of personalized aspects. This custom mouthguard offers the users input on every aspect of the production, to guarantee consumer protection and satisfaction.

### BRIEF DESCRIPTION OF THE VIEWS

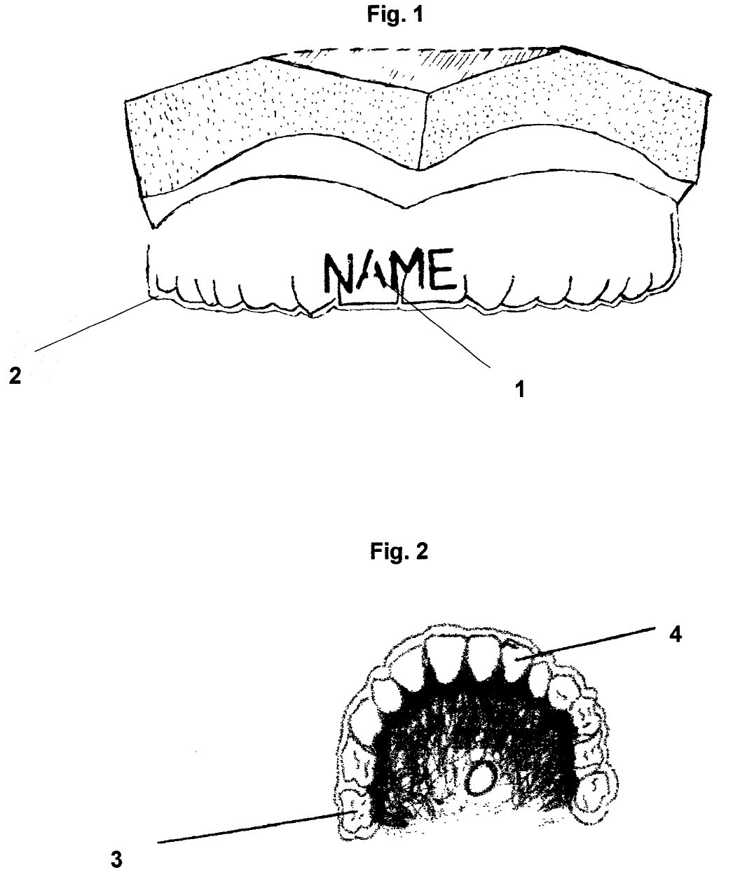

FIG. 1) is a frontal view of the mouthguard showing one embodiment of the present invention with an image engraved onto the anterior incisor region of the mouthguard constructed in accordance with one embodiment of the previous claims.

FIG. 2) is an inferior view of the mouthguard showing the biting source consisting of the posterior molars and bicuspids.

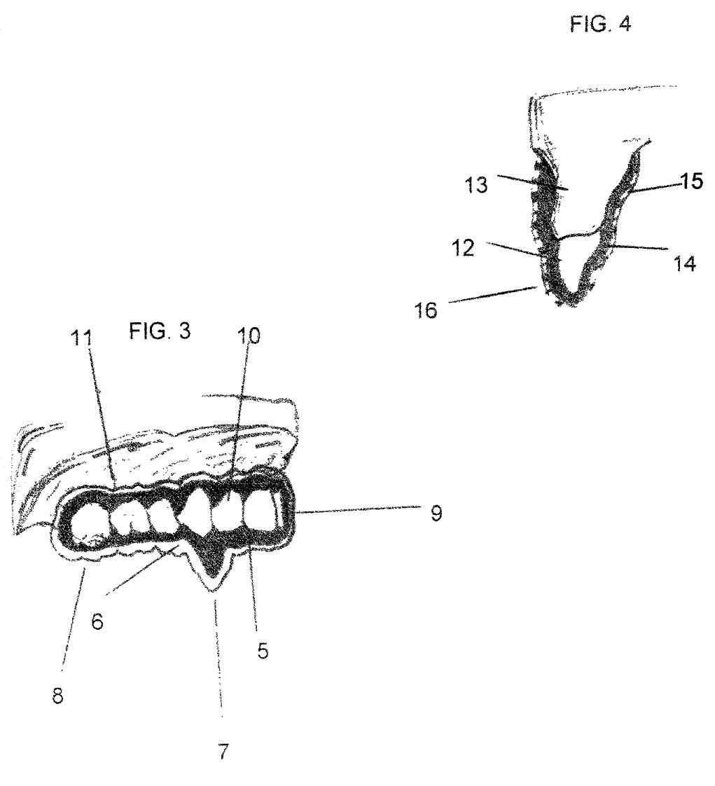

FIG. 3) is a side phantom view of the mouthguard constructed in accordance with one embodiment of the present invention.

FIG. 4) is the side cut away view of the mouthguard constructed in accordance with the one embodiment of the present invention displaying the relationship of the gums and teeth to the mouthguard.

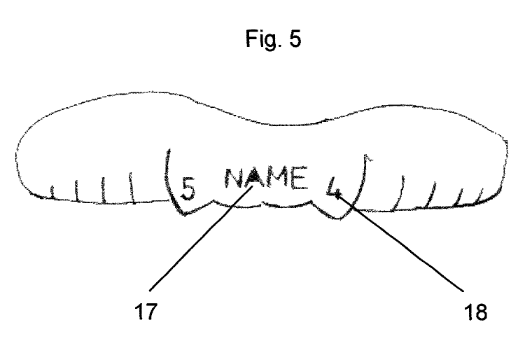

FIG. 5) is a frontal view of a modified form of the present invention with elongated incisors and engraved words onto the anterior incisors.

### DESCRIPTION OF THE EMBODIMENTS

There may be other modifications and changes obvious to those of ordinary skill in the art that fall within the scope of the present invention. Therefore, the following description is not to be taken in a limiting sense, and the scope of the present invention is defined by the aforementioned claims and their equivalents.

The image in FIG. 1 illustrates the frontal view of the mouthguard. This view point displays an image engraved onto the anterior incisor area Marker 1, without elongated canines. This mouthguard as recited in the before mentioned claims is composed of two layers of EVA approved plastic laminated thermoplastic material. Marker 2 displays the relation of the plastic laminate material to the teeth. FIG. 2 displays the inferior area of the mouthguard illustrating the rear molar and bicuspid area that makes up the contact surface for the lower teeth Marker 3, and the mouthguard's relation to the teeth and gums Marker 4.

The mouthguard in FIG. 3 illustrates a manipulated form in a phantom side view displaying the layers of plastic laminate material. Marker #5 shows the base (primary) layer of EVA grade plastic laminate material consisting of a thickness of 0.80 mm. The base layer is manipulated by hand to form the elongated canines marker #7 and engraved by the laser to produce an image on the anterior incisors marker #9. Marker #6 is the clear plastic laminate thermoformed layer that covers the manipulated (base) layer marker #5. The EVA grade plastic laminated material represented by marker #6 consists of a density of 0.08 mm. A thinner layer is used because it does not significantly increase the thickness of the unit and it covers the engraving and paint. Marker #8 refers to the contact surface for the lower teeth, interdentated for the proper range of movement and fit that reduces temporomandibular joint discomfort. Marker #10 refers to the teeth and their relation to the inner cavity formed within the base by the vaccuforming machine upon the upper impression of the initial mold. Marker #11 refers to the relationship of the upper gum line to the mouthguard. The upper gum line is not effected by the mouthguard because the excess materials are trimmed during the initial forming stages on the base layer.

FIG. 4 shows a side cut away view of the mouthguard as seen on the anterior incisors within the cavity formed by the primary layer of material. Marker #12 displays the relationship of the anterior incisors and the gums (marker #13) to the cavity formed by the base layer marker #14. The clear layer of thermoplastic material is shown in marker #15. The clear layer is formed by a layer of material bonded to the primary layer. Finally, marker #16 shows the anterior area of the mouthguard and the area that will be visible to the observer that displays the image engraved onto the base layer.

FIG. 5 shows a modified view of the present invention where the anterior incisor region of the mouthguard is engraved with letters between the incisors Marker #17 and, numbers onto the elongated incisors Marker #18.

It should be understood that the above description is intended to be illustrative, and not restrictive. Many other embodiments will be apparent to those of skill in the art upon reading and deciphering the above description. The scope of the invention should, therefore, be determined with reference to the appended claims, along with the full scope of equivalents to which such claims are entitled.

What is claimed is:

1) A mouthguard consisting of;
Two layers of pressure laminated thermoplastic material consisting of a different thickness comprising a base layer and a transparent layer, having a general U-shape produced by thermoforming the plastic laminate material over an impression of a donor's upper teeth, (incisors, canines, molars, and bicuspids) terminating at the base of the gum line forming a channel for the upper teeth and gum line and,
a method using a laser to engrave an image, numbers, or letters into the primary base layer of the mouthguard onto the anterior incisor area, then painting said area free hand or by using an airbrush applicator to distinguish the base from the engraved area.

2) A mouthguard wherein the base layer is manipulated within 5-10 seconds after thermoforming to form the elongated canines by hand.

3) A mouthguard comprising:
(a). A mouthguard base having a general U-shape, formed of a plastic laminate material contributing to the primary layer by a vaccuforming a piece of thermoplastic material upon the upper impression of the users teeth and gums, wherein the base layer is manipulated within 5-10 seconds of forming by hand to create the elongated canines, the mouthguard base defined in part by an internal and external surface, the internal surface forming a channel exactly matching the shape and contours of the upper impression of the incisors, canines and the gum line, the external surface of the base serving as a contact surface for the second (final) layer of plastic material;
(b.) The mouthguard having a base layer covered entirely with masking tape and engraved with a laser, producing an image, and said image painted then let to dry prior to removing the masking tape;
(c.) The mouthguard base is heated for up to 4 minutes then immediately covered by a second layer of clear pressure laminated thermoplastic material, the posterior surface forming a contact surface for the lower teeth (molars and bicuspids) wherein the rear molars and bicuspids are interdentated.

4) A mouthguard wherein the second layer of clear thermoplastic material comprises of the contact surface for the lower teeth (molars and bicuspids) where the second layer is interdentated forming a contact surface for the lower teeth matching the contours of the lower rear molars and bicuspids to provide superior temporomandibular joint comfort, consisting of a material no thicker than 0.08 mm.
